(19) United States
(12) Patent Application Publication
(10) Pub. No.: US 2013/0321146 A1
(43) Pub. Date: Dec. 5, 2013

(54) SYSTEMS AND METHODS FOR ENSURING SAFETY OF SKIERS TO ANTICIPATE DANGEROUS SPOTS

(71) Applicant: Yay Wai Edwin Kwong, Hong Kong (HK)

(72) Inventor: Yay Wai Edwin Kwong, Hong Kong (HK)

(21) Appl. No.: 13/486,808

(22) Filed: Jun. 1, 2012

(51) Int. Cl. G08B 1/08

(52) U.S. Cl. 340/539.13

(57) ABSTRACT

Systems and methods are provided for ensuring safety of skiers to anticipate dangerous spots. In one embodiment, a system is provided for ensuring safety of a skier to anticipate dangerous spots on current path and warn the skier about the dangerous spots based on the current speed and direction of the skier, in accordance with accidents in the past in light of locations.

### FIELD OF THE INVENTION

This invention generally relates to sports injuries in skiing. Specifically, this invention relates to information to skiers about dangerous spots during skiing to skiers.

### BACKGROUND OF THE INVENTION

On the average, there are more than 30 deaths a year for skiers. Even though many have seen the sport as a safe sport, unless there is proper training and equipment, it is very common to at least cause different kinds of sport injuries, ranging from ankle sprain to broken foot or arm. Most of the time, however, the injured person has lost control, often travelling too fast for the prevailing conditions and on a slope inappropriate to their ability level. To some, many accidents and other falls can be avoided because they occur due to sheer carelessness of skiers. The key is how to stay safe during skiing. Of course, good and sound equipment helps. But the key is for the skiers to anticipate danger ahead of time. For example, if a skier can be informed about the upcoming shape or curviness of the upcoming trail, the skier can pay more attention to slow down from current pace. As another example, if there are ways to inform the skier on how to change the movement of ski and pole, the chances of getting injured are reduced. By doing so, many won't be tempted to overstate their level of skill and ability, as some slopes are more difficult to turn and bindings set too high for your ability are more likely to cause injury. In view of the forgoing challenges, there is a need for methods and systems for skiers to reduce sports injuries during exercising of the sport.

### SUMMARY OF THE INVENTION

This invention is directed to a skiing safety system for ensuring safety of a skier to anticipate dangerous spots on current path and warn the skier about the dangerous spots based on the current speed and direction of the skier, in accordance with accidents in the past in light of locations. In one embodiment, a skilling system comprises a ski pole; a ski; a GPS receiver included in the ski, wherein the GPS receiver can be configured to detect current speed and direction of the skier; and identify current location of the skier; an accelerometer device included in the ski configured to detect current movements of the ski; an accelerometer device included in the ski pole configured to detect current movements of the ski pole; a goggle comprising: a rf reader included in the goggle synchronized with the ski pole and ski, wherein the rf reader receives information from the ski pole and ski, regarding the speed, movements, and acceleration of the ski and the movements of the ski pole; a speaker included in the goggle to inform the user about the anticipated danger in the current path and hinting alternatives to avoid the danger; an accelerometer included in the goggle that detects whether a location detector included in the goggle that detects the current location of the skier, detects speed of the skier, detects acceleration of the skier, detects inclination of slope on which the skier is skiing; a electronic map included in the goggle, wherein the map identifies dangerous spots by location; a processor included in the goggle; and a memory, wherein the memory comprises a method including detecting conditions of the skier, wherein the detection includes: determining current location of the skier, based on detection from the GPS receiver detected from the skier; determining current speed, acceleration, and direction of the skier, based on detection from the GPS receiver detected from the skier; identifying the dangerous spots in the neighborhood of the skier, based on the dangerous spots identified in the electronic map, the current and expected location of the skier, in light of the determined speed, acceleration, and direction headed by the skier; informing the skier about the identified dangerous spots, by using the speaker included in the goggle; providing suggestions to the skier to avoid the dangerous spots, wherein the suggestions include: using the accelerometer device included in the ski to detect current movements of the ski maneuvered by the skier; and using the accelerometer device included in the ski pole to detect current movements of the ski pole maneuvered by the skier; and informing the skier about the suggestions to avoid the dangerous spots, by using the speaker included in the goggle, comprising: based on current movements of the ski and ski pole, adjusting direction of the ski and ski pole to change direction of the skier; based on current movements of the ski and ski pole, adjusting degree of change of the ski and ski pole; based on current movements of the skier, suggesting change of body movements of the skier; and based on current movements of the skier, ski, and ski pole, suggesting urgency of the change.

One embodied feature may includes detecting conditions of the skier, wherein the detection includes: determining current location of the skier, based on detection from the GPS receiver detected from the skier; determining current speed, acceleration, and direction of the skier, based on detection from the GPS receiver detected from the skier; identifying the dangerous spots in the neighborhood of the skier, based on the dangerous spots identified in the electronic map, the current and expected location of the skier, in light of the determined speed, acceleration, and direction headed by the skier; and informing the skier about the identified dangerous spots, by using the speaker included in the goggle, wherein the dangerous spots include hitting a tree and falling off a cliff; providing suggestions to the skier to avoid the dangerous spots, wherein the suggestions include: using the accelerometer device included in the ski to detect current movements of the ski maneuvered by the skier; using the accelerometer device included in the ski pole to detect current movements of the ski pole maneuvered by the skier; informing the skier about the suggestions to avoid the dangerous spots, by using the speaker included in the goggle, comprising: based on current movements of the ski and ski pole, adjusting direction of the ski and ski pole to change direction of the skier; based on current movements of the ski and ski pole, adjusting degree of change of the ski and ski pole; based on current movements of the skier, suggesting change of body movements of the skier; and based on current movements of the skier, ski, and ski pole, suggesting urgency of the change.

In an addition embodied feature, the exemplary system may perform determining current location of the skier, based on detection from the GPS receiver detected from the skier; determining current speed, acceleration, and direction of the skier, based on detection from the GPS receiver detected from the skier; identifying the dangerous spots in the neighborhood of the skier, based on the dangerous spots identified in the electronic map, the current and expected location of the skier, in light of the determined speed, acceleration, and direction headed by the skier; and informing the skier about the identified dangerous spots, by using the speaker included in the goggle, wherein the dangerous spots include hitting a tree and falling off a cliff; providing suggestions to the skier to avoid the dangerous spots, wherein the suggestions include: using the accelerometer device included in the ski to detect current movements of the ski maneuvered by the skier; using the accelerometer device included in the ski pole to detect current movements of the ski pole maneuvered by the skier; informing the skier about the suggestions to avoid the dangerous spots, by using the speaker included in the goggle, comprising: based on current movements of the ski and ski pole, adjusting direction of the ski and ski pole to change direction of the skier; based on current movements of the ski and ski pole, adjusting degree of change of the ski and ski pole; based on current movements of the skier, suggesting change of body movements of the skier; and based on current movements of the skier, ski, and ski pole, suggesting urgency of the change.

### BRIEF DESCRIPTION OF THE DRAWINGS

FIG. 1 illustrates a ski dangerous spot detection system, consistent with an embodiment of the present invention.

### DETAILED DESCRIPTION

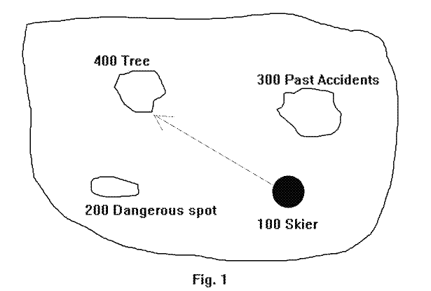

Referring to FIG. 1 to illustrate an implementation of the present invention. In the FIGURE, a skiing safety system is provided for ensuring safety of a skier to anticipate dangerous spots on current path and warn the skier about the dangerous spots based on the current speed and direction of the skier. The system comprises: a ski pole; a ski; a GPS receiver included in the ski, wherein the GPS receiver can be configured to: detect current speed and direction of the skier; and identify current location of the skier; an accelerometer device included in the ski configured to detect current movements of the ski; an accelerometer device included in the ski pole configured to detect current movements of the ski pole; a goggle comprising: a rf reader included in the goggle synchronized with the ski pole and ski, wherein the rf reader receives information from the ski pole and ski, regarding the speed, movements, and acceleration of the ski and the movements of the ski pole; a speaker included in the goggle to inform the user about the anticipated danger in the current path and hinting alternatives to avoid the danger; an accelerometer included in the goggle that detects whether a location detector included in the goggle that detects the current location of the skier, detects speed of the skier, detects acceleration of the skier, detects inclination of slope on which the skier is skiing; a electronic map included in the goggle, wherein the map identifies dangerous spots by location; a processor included in the goggle; and a memory storing instructions that cause the processor to execute a method, the method comprising: detecting conditions of the skier, wherein the detection includes: determining current location of the skier, based on detection from the GPS receiver detected from the skier; determining current speed, acceleration, and direction of the skier, based on detection from the GPS receiver detected from the skier; identifying the dangerous spots in the neighborhood of the skier, based on the dangerous spots identified in the electronic map, the current and expected location of the skier, in light of the determined speed, acceleration, and direction headed by the skier; informing the skier about the identified dangerous spots, by using the speaker included in the goggle; and providing suggestions to the skier to avoid the dangerous spots.

Multiple suggestions can be provided to the skier. In this example, an accelerometer is used. The accelerometer device included in the ski can be used to detect current movements of the ski maneuvered by the skier; and using the accelerometer device included in the ski pole to detect current movements of the ski pole maneuvered by the skier; and informing the skier about the suggestions to avoid the dangerous spots, by using the speaker included in the goggle, comprising: based on current movements of the ski and ski pole, adjusting direction of the ski and ski pole to change direction of the skier; based on current movements of the ski and ski pole, adjusting degree of change of the ski and ski pole; based on current movements of the skier, suggesting change of body movements of the skier; and based on current movements of the skier, ski, and ski pole, suggesting urgency of the change.

In a different aspect, the GPS receiver of the skiing safety system can be configured to detect current speed and direction of the skier; and identify current location of the skier; an accelerometer device included in the ski configured to detect current movements of the ski; an accelerometer device included in the ski pole configured to detect current movements of the ski pole; a goggle comprising: a rf reader included in the goggle synchronized with the ski pole and ski, wherein the rf reader receives information from the ski pole and ski, regarding the speed, movements, and acceleration of the ski and the movements of the ski pole; a speaker included in the goggle to inform the user about the anticipated danger in the current path and hinting alternatives to avoid the danger; an accelerometer included in the goggle that detects whether a location detector included in the goggle that detects the current location of the skier, detects speed of the skier, detects acceleration of the skier, detects inclination of slope on which the skier is skiing; a electronic map included in the goggle, wherein the map identifies dangerous spots by location; a processor included in the goggle; and a memory storing instructions that cause the processor to execute a method, the method comprising: detecting conditions of the skier, wherein the detection includes: determining current location of the skier, based on detection from the GPS receiver detected from the skier; determining current speed, acceleration, and direction of the skier, based on detection from the GPS receiver detected from the skier; identifying the dangerous spots in the neighborhood of the skier, based on the dangerous spots identified in the electronic map, the current and expected location of the skier, in light of the determined speed, acceleration, and direction headed by the skier; and informing the skier about the identified dangerous spots, by using the speaker included in the goggle, wherein the dangerous spots include hitting a tree and falling off a cliff; providing suggestions to the skier to avoid the dangerous spots, wherein the suggestions include: using the accelerometer device included in the ski to detect current movements of the ski maneuvered by the skier; using the accelerometer device included in the ski pole to detect current movements of the ski pole maneuvered by the skier; informing the skier about the suggestions to avoid the dangerous spots, by using the speaker included in the goggle, comprising: based on current movements of the ski and ski pole, adjusting direction of the ski and ski pole to change direction of the skier; based on current movements of the ski and ski pole, adjusting degree of change of the ski and ski pole; based on current movements of the skier, suggesting change of body movements of the skier; and based on current movements of the skier, ski, and ski pole, suggesting urgency of the change.

Further, the accelerometer device included in the ski pole can be configured to detect current movements of the ski pole, so that the goggle can be synchronized with the rf reader, ski pole, and ski. The rf reader receives information from the ski pole and ski, regarding the speed, movements, and acceleration of the ski and the movements of the ski pole; a speaker included in the goggle to inform the user about the anticipated danger in the current path and hinting alternatives to avoid the danger; an accelerometer included in the goggle that detects whether a location detector included in the goggle that detects the current location of the skier, detects speed of the skier, detects acceleration of the skier, detects inclination of slope on which the skier is skiing; a electronic map included in the goggle, wherein the map identifies dangerous spots by location, according to past accidents; a processor included in the goggle; and a memory storing instructions that cause the processor to execute a method, the method comprising: detecting conditions of the skier, wherein the detection includes: determining current location of the skier, based on detection from the GPS receiver detected from the skier; determining current speed, acceleration, and direction of the skier, based on detection from the GPS receiver detected from the skier; identifying the dangerous spots in the neighborhood of the skier, based on the dangerous spots identified in the electronic map, the current and expected location of the skier, in light of the determined speed, acceleration, and direction headed by the skier; and informing the skier about the identified dangerous spots, by using the speaker included in the goggle, wherein the dangerous spots include hitting a tree and falling off a cliff; providing suggestions to the skier to avoid the dangerous spots, wherein the suggestions include: using the accelerometer device included in the ski to detect current movements of the ski maneuvered by the skier; using the accelerometer device included in the ski pole to detect current movements of the ski pole maneuvered by the skier; informing the skier about the suggestions to avoid the dangerous spots, by using the speaker included in the goggle, comprising based on current movements of the ski and ski pole, adjusting direction of the ski and ski pole to change direction of the skier; based on current movements of the ski and ski pole, adjusting degree of change of the ski and ski pole; based on current movements of the skier, suggesting change of body movements of the skier; and based on current movements of the skier, ski, and ski pole, suggesting urgency of the change.

What is claimed is:

1. A skiing safety system for ensuring safety of a skier to anticipate dangerous spots on current path and warn the skier about the dangerous spots based on the current speed and direction of the skier, in accordance with accidents in the past in light of locations, comprising:
a ski pole;
a ski;
a GPS receiver included in the ski, wherein the GPS receiver can be configured to:
detect current speed and direction of the skier; and
identify current location of the skier;
an accelerometer device included in the ski configured to detect current movements of the ski;
an accelerometer device included in the ski pole configured to detect current movements of the ski pole;
a goggle comprising:
a rf reader included in the goggle synchronized with the ski pole and ski, wherein the rf reader receives information from the ski pole and ski, regarding the speed, movements, and acceleration of the ski and the movements of the ski pole;
a speaker included in the goggle to inform the user about the anticipated danger in the current path and hinting alternatives to avoid the danger;
an accelerometer included in the goggle that detects whether a location detector included in the goggle that detects the current location of the skier, detects speed of the skier, detects acceleration of the skier, detects inclination of slope on which the skier is skiing;
a electronic map included in the goggle, wherein the map identifies dangerous spots by location;
a processor included in the goggle; and
a memory.

2. The system of claim 1, wherein the method comprises:
detecting conditions of the skier, wherein the detection includes:
determining current location of the skier, based on detection from the GPS receiver detected from the skier;
determining current speed, acceleration, and direction of the skier, based on detection from the GPS receiver detected from the skier;
identifying the dangerous spots in the neighborhood of the skier, based on the dangerous spots identified in the electronic map, the current and expected location of the skier, in light of the determined speed, acceleration, and direction headed by the skier;
informing the skier about the identified dangerous spots, by using the speaker included in the goggle;
providing suggestions to the skier to avoid the dangerous spots, wherein the suggestions include:
using the accelerometer device included in the ski to detect current movements of the ski maneuvered by the skier; and
using the accelerometer device included in the ski pole to detect current movements of the ski pole maneuvered by the skier; and
informing the skier about the suggestions to avoid the dangerous spots, by using the speaker included in the goggle, comprising:
based on current movements of the ski and ski pole, adjusting direction of the ski and ski pole to change direction of the skier;
based on current movements of the ski and ski pole, adjusting degree of change of the ski and ski pole;
based on current movements of the skier, suggesting change of body movements of the skier; and
based on current movements of the skier, ski, and ski pole, suggesting urgency of the change.

3. The system of claim 1, wherein the method comprises:
detecting conditions of the skier, wherein the detection includes:
determining current location of the skier, based on detection from the GPS receiver detected from the skier;
determining current speed, acceleration, and direction of the skier, based on detection from the GPS receiver detected from the skier;
identifying the dangerous spots in the neighborhood of the skier, based on the dangerous spots identified in the electronic map, the current and expected location of the skier, in light of the determined speed, acceleration, and direction headed by the skier; and
informing the skier about the identified dangerous spots, by using the speaker included in the goggle, wherein the dangerous spots include hitting a tree and falling off a cliff;
providing suggestions to the skier to avoid the dangerous spots, wherein the suggestions include:
using the accelerometer device included in the ski to detect current movements of the ski maneuvered by the skier;
using the accelerometer device included in the ski pole to detect current movements of the ski pole maneuvered by the skier;
informing the skier about the suggestions to avoid the dangerous spots, by using the speaker included in the goggle, comprising:
based on current movements of the ski and ski pole, adjusting direction of the ski and ski pole to change direction of the skier;
based on current movements of the ski and ski pole, adjusting degree of change of the ski and ski pole;
based on current movements of the skier, suggesting change of body movements of the skier; and
based on current movements of the skier, ski, and ski pole, suggesting urgency of the change.

4. The system of claim 1, wherein the method comprises:
detecting conditions of the skier, wherein the detection includes:
determining current location of the skier, based on detection from the GPS receiver detected from the skier;
determining current speed, acceleration, and direction of the skier, based on detection from the GPS receiver detected from the skier;
identifying the dangerous spots in the neighborhood of the skier, based on the dangerous spots identified in the electronic map, the current and expected location of the skier, in light of the determined speed, acceleration, and direction headed by the skier; and
informing the skier about the identified dangerous spots, by using the speaker included in the goggle, wherein the dangerous spots include hitting a tree and falling off a cliff;
providing suggestions to the skier to avoid the dangerous spots, wherein the suggestions include:
using the accelerometer device included in the ski to detect current movements of the ski maneuvered by the skier;
using the accelerometer device included in the ski pole to detect current movements of the ski pole maneuvered by the skier;
informing the skier about the suggestions to avoid the dangerous spots, by using the speaker included in the goggle, comprising:
based on current movements of the ski and ski pole, adjusting direction of the ski and ski pole to change direction of the skier;
based on current movements of the ski and ski pole, adjusting degree of change of the ski and ski pole;
based on current movements of the skier, suggesting change of body movements of the skier; and
based on current movements of the skier, ski, and ski pole, suggesting urgency of the change.
